(19) United States
(12) Patent Application Publication
(10) Pub. No.: US 2008/0098907 A1
(43) Pub. Date: May 1, 2008

(54) Apparatus for retaining, heating and dispensing food products on a FIFO basis

(76) Inventors: Todd Peters, Hustisford, WI (US); Neal L. Pearlman, Evanston, IL (US)

Correspondence Address: ILLINOIS TOOL WORKS INC., 3600 WEST LAKE AVENUE, PATENT DEPARTMENT, GLENVIEW, IL, 60025, US

(21) Appl. No.: 11/788,596

(22) Filed: Apr. 20, 2007

Related U.S. Application Data
(60) Provisional application No. 60/854,814, filed on Oct. 27, 2006.

(51) Int. Cl. A47J 36/26; A47J 36/24

(52) U.S. Cl. 99/483

(57) ABSTRACT

A food receptacle and modular heating apparatus 10 adapted to retain, heat, and dispense a quantity of food products 12 on a first-in-first-out (FIFO) basis, and to be facilely dismantled by a human user, including a main housing 20 defining an interior space 30, an inlet 22 and an outlet 24, and further including manually removable inlet and outlet doors 26,28, a heating module 14 manually disconnectable from the housing 20 and configured to heat the products 12 by introducing heated air in the space 30 within a minimum distance from the outlet 24, and a manually removable false bottom 32 and interior baffle 34 for directing products 12 away from the inlet 22 and towards the outlet 24.

### BACKGROUND OF THE INVENTION

1. Field of the Invention

The present invention relates generally to systems and apparatuses for retaining, heating, and dispensing food products. More particularly, the invention concerns a facilely dismountable food receptacle and modular heating apparatus that defines an inlet and outlet, is configured to dispense the products on a first-in-first-out (“FIFO”) basis, and comprises a detached heating module, interior baffle, false bottom, inlet door, and outlet door.

2. Discussion of Prior Art

Conventional food heating apparatuses have been developed for use by the restaurant, food processing, and food preparation industries. A preferred type of apparatus includes a heating module and food receptacle interconnected by fasteners, and is configured to dispense on a FIFO basis various food products, such as chips, rolls, muffins, or other common appetizers or accompaniments frequently served and better consumed warm. In this type, the receptacle typically presents an inlet, a separate outlet and integrated interior structure for directing the products. The positioning of the outlet and inlet, as well as the configuration of the structure cause the products to be dispensed sequentially, as it is appreciated that doing so increases the likelihood that a dispensed product has been exposed to treatment for a minimum period. Finally, inlet and outlet doors, such as is shown in prior art FIG. 1, are pivotally attached to the receptacle and provided to enclose and enable access to the interior space formed by the housing. U.S. Pat. Nos. 4,803,921 to Nuss, and U.S. Pat. No. 4,776,317 to Pinnow et al. disclose exemplary embodiments of FIFO units.

Often neglected in the design considerations of food heating apparatuses, including FIFO units, however, are the necessary and laborious steps of cleaning, maintenance and repair after treating the products. As a result, unnecessary man-hour expenses are experienced in the operation cycle of each apparatus. For example, it is typical for a user to have to “break-down” (i.e., to dismantle the apparatus so as to expose its interstitial spaces) the apparatus in order to facilitate the manual removal of food particles, residue and/or substances that adhere to or become entrapped within the receptacle. In doing so, the user typically uses tools, such as screwdrivers or wrenches, to remove and replace the fasteners. Few accommodations have been made to facilitate these post-treatment steps.

Where dismantling is not performed, a user attempting to clean the apparatus by inserting and navigating his or her hand or a cleaning tool within the interior space may not be able to clear all of the air-ducts of the heating module. Moreover, the interior space defined by the housing may likewise become clogged or partially obstructed with food particles.

Another concern presented by conventional food heating apparatuses results where heated air is introduced away from the outlet, and the temperature is also measured away from the outlet. In this configuration, it may not be appreciated by the apparatus that food products and the space at or near the outlet are at a lower temperature than the desired and indicating temperature.

Thus, despite improvements in the art, including the treatment advantages offered by FIFO apparatuses, there remains a long felt need for an improved apparatus that is easier to break-down, so as to facilitate and streamline post-treatment cleaning, maintenance and/or repair, and that better assures adequate treatment of dispensed products.

### SUMMARY OF THE INVENTION

Responsive to these and other concerns, the present invention presents a food receptacle and modular heating apparatus adapted to retain, heat, and dispense food products on a FIFO basis. The inventive apparatus is configured to be facilely dismantled by a human user, and comprises a main housing defining an interior space wherein the products are retained, and heated; a heating module positionable adjacent the housing, and configured to heat at least a portion of the space to a predetermined minimum temperature; and a holding element configured to interconnect the module and housing, and generate a holding force therebetween. The housing further defines an inlet communicatively coupled to the space and configured to receive the food products, and an outlet spaced from the inlet, communicatively coupled to the space and configured to dispense the products. The holding element is manually operable by the user, such that the module is connectable to and disconnectable from the housing without the use of a tool. Finally, the heating module includes an exterior frame configured to solely secure the components and constituent circuits necessary to heat the space, and as such presents a modular apparatus that further facilitates dismantling.

Other preferred aspects presented by the invention and excluded in the prior art include without limitation, detachable inlet and outlet doors, a detachable baffle and false bottom housed within the interior space and configured to direct the products from the inlet and towards the outlet, a holding element configured to provide mechanical advantage to the user, and positioning within a minimum distance from the outlet a set of louvers fluidly coupled to the heating module.

Among the advantages over the prior art, the inventive apparatus presents a modular heating unit that is manually connectable to and disconnectable from a food receptacle, manually removable inlet and outlet doors, and a manually removable internal baffle that combine to make the apparatus significantly easier to “break-down,” thereby recouping man-hour and labor related expenses. This in turn, streamlines and facilitates cleaning, maintenance, and/or repair. The advantage of assuring sufficiently heated products by positioning a heated air register (set of louvers) within a minimum distance from the outlet is also realized. Of yet further advantage is the closed loop heated airflow offered by a preferred embodiment of the invention, and the correlative increase in thermal efficiency.

These and other features, aspects, and advantages of the present invention are discussed in greater detail in the section below titled DESCRIPTION OF THE PREFERRED EMBODIMENT.

### BRIEF DESCRIPTION OF THE DRAWINGS

A preferred embodiment of the present invention is described in detail below with reference to the attached drawing figures, wherein:

FIG. 1 is a fragmental view of a prior art inlet or outlet door attachment of a conventional food-heating receptacle, particularly illustrating a fastened brace;

FIG. 2 is a front isometric view of a FIFO food heating apparatus, including a food receptacle and heating module, in accordance with a preferred embodiment of the present invention;

FIG. 3 is a rear isometric view of the apparatus shown in FIG. 1, particularly illustrating the interconnection between the heating module and food receptacle, and the inlet door in the closed condition;

FIG. 4 is a top view of the apparatus, particularly illustrating an uppermost inlet and inlet door;

FIG. 5 is a typical side elevation of the apparatus, particularly illustrating the module, housing, inlet door handle, holding element, and a bin outlet door in a ninety-degree open condition;

FIG. 6 is an enlarged view of the holding element shown in FIG. 5, in accordance with a preferred embodiment of the invention;

FIG. 7 is a front elevation of the apparatus, particularly illustrating an outlet door;

FIG. 8 is a cross-section of the housing and module shown in FIG. 7, particularly illustrating a plenum, blower, heating unit, and the resulting airflow, in accordance with a preferred embodiment of the present invention;

FIG. 9 is a perspective view of the interior of the housing in accordance with a preferred embodiment of the present invention, particularly illustrating a detached baffle, and a detached false bottom defining a first set of louvers;

FIG. 9a is a perspective view of a detached baffle, in accordance with a second embodiment of the invention;

FIG. 10 is a cross-section of a housing and module, particularly illustrating a plenum, blower, heating unit, and the resulting airflow, in accordance with a second preferred embodiment of the present invention;

FIG. 11 is a cross-section of a housing and module, particularly illustrating a plenum, blower, heating unit, false back, and the resulting airflow, in accordance with a third preferred embodiment of the present invention;

FIG. 12 is a perspective view of a slidably removable inlet door (with prior positioning shown in hidden line) and inlet tracks attached to the housing, in accordance with a preferred embodiment of the invention;

FIG. 13 is an enlarged segmental view of the inlet, inlet track, and a holding tab at the end of the track shown in FIG. 12;

FIG. 14 is an enlarged perspective view of the outlet and an outlet door, particularly illustrating manually removable shoulder bolts, in accordance with a preferred embodiment of the invention;

FIG. 15 is a front elevation view of the outlet door and outlet in accordance with a first preferred embodiment of the invention, particularly illustrating an outlet insertable section, flange flaps and outlet notches;

FIG. 16 is a front elevation view of the outlet door and outlet in accordance with a second preferred embodiment of the invention, particularly illustrating a pin and wheel assemblies, and an upper flange race; and

FIG. 16a is a side elevation view of the outlet door, race, and pin/wheel assembly shown in FIG. 16.

### DESCRIPTION OF THE PREFERRED EMBODIMENT

With reference to the figures, a food receptacle and heating apparatus 10 and method of heating a quantity of food products 12 are herein described and otherwise disclosed in accordance with a preferred embodiment of the present invention. Broadly, the present invention concerns an apparatus 10 that is facilely dismountable by a human user (not shown), and allows for the retention, heating, and dispensing of the food products 12 by the user on an improved FIFO basis. As used herein, the term “facilely dismountable” shall mean that no greater than the average level of skill and generative force produced by an average human user is required to dismantle the apparatus, and the terms “manual,” or “manually” shall mean by the use of a hand of a human user without the aid of a tool, including a screwdriver, wrench, chain, or bar.

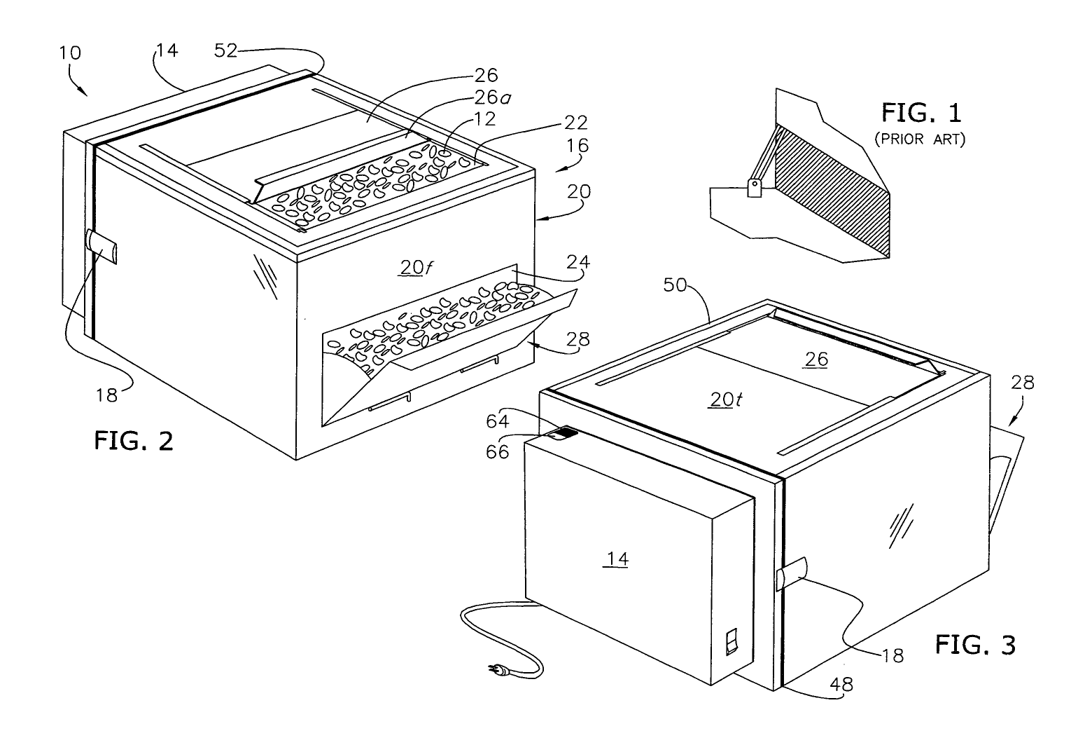

Referring to FIGS. 2 through 8, the apparatus 10 includes a heating module 14 and food receptacle 16 interconnected by a manually operable holding element 18. The receptacle 16 comprises a main housing 20 that defines an inlet 22 and an outlet 24 spaced from the inlet 22. More preferably, the receptacle 16 further includes an inlet door 26 having an integral door handle 26a, translatable between open and closed conditions, and configured to at least substantially cover the inlet 22 when in the closed condition (FIG. 3), and an outlet door 28 having an integral door handle 28a, translatable between open and closed conditions, and configured to at least substantially cover the outlet 24 when in the closed condition.

The housing 20 defines an interior space 30 (FIG. 8) that is fluidly coupled to the inlet 22 and outlet 24. Exemplary housing dimensions may include a height of 48.9 cm (19.25 in.), a depth of 56.5 cm (22.250 in.), and a width of 61.6 cm (24.250 in). The housing 20 preferably defines the inlet 22 at or near the uppermost member (or top side) 20t, and the foremost member (or front side) 20f of the housing preferably defines the outlet 24 near its bottom, so as to facilitate FIFO progression. Where a height of 48.9 cm is utilized, the housing 20 may position the outlet 24 so as to be 7.6 cm (3.0 in.) from the bottom. This allows the door handle 28a and door 28 to achieve a ninety-degree open condition (FIG. 5), when the apparatus is placed on a flat surface. In the illustrated embodiment, a false bottom 32 (FIG. 8) truncates the space 30 and raises the food products 12 to the elevation of the outlet 24, which results in a volumetric capacity of approximately five cubic feet (or 17.5 pounds of tortilla chips).

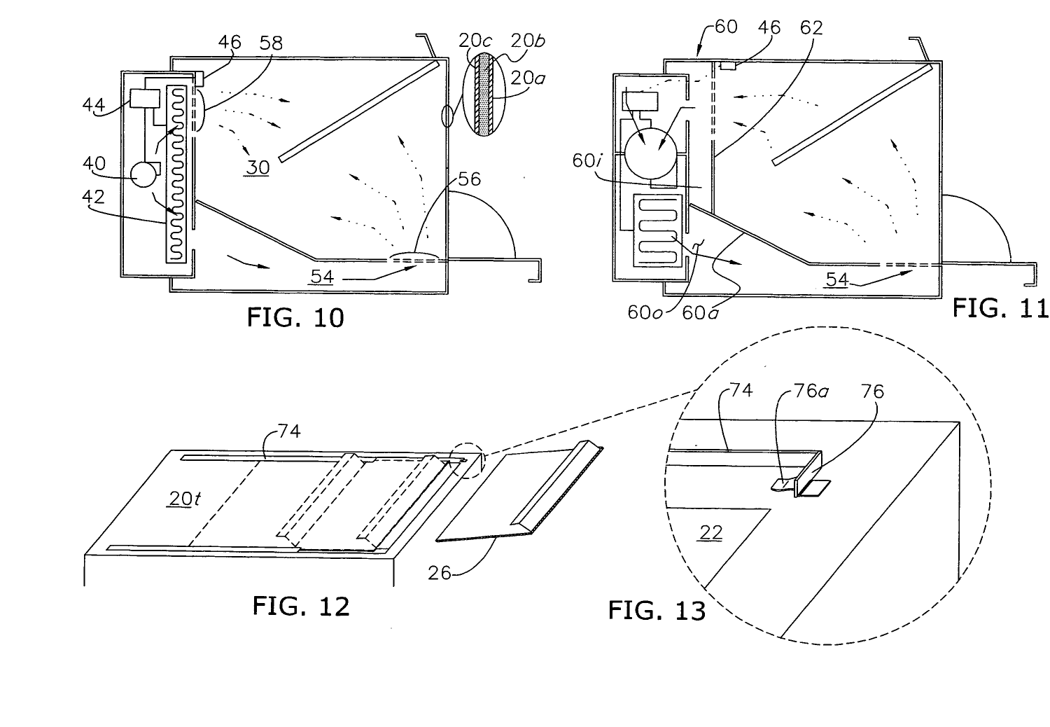

The housing 20 is formed of a suitable material, such as 18 gauge stainless steel; with the exception that the exterior members or sides of the housing 20 may alternatively be formed of a multi-layered wall (FIG. 10), including a protective exterior layer 20a, an insulation layer 20b, and an interior layer 20c that is heat resistant, non-corrosive, and non-reactive to the food products.

To further facilitate FIFO progression, the housing 20 preferably includes at least one declined baffle (or diverter plate) 34 configured to direct the products 12 away from the inlet 22, towards the back of the space 30, and ultimately towards the outlet 24 (FIGS. 8 through 11). The baffle 34 also serves the function of preventing some of the products 12 from entering the region 30b beneath the baffle 34 until products 12 are removed therefrom. The preferred baffle 34 presents a screen extending within the space 30 from the front member 20f to a depth less than the full depth of the space 30 at a downward slope (e.g., minus 15 to 45 degrees). The preferred baffle 34 is secured by gravity and a plurality of supports 36 attached to the inside of the housing 20 (FIG. 9a), but is detached from the supports 36 so as to be manually removable by the user. Alternatively, where the food products 12 present a minimum diameter, the baffle 34 may define a plurality of through holes 38 (FIG. 9a) that each present a maximum diameter less than the minimum product diameter, so as to allow the passage of air but not food products 12. The distance between the end of the baffle 34 and the rear extremity of the space 30 is such that a plurality of food products 12 can concurrently pass from the upper region 30a to the lower region 30b.

As alternatively shown in FIGS. 8, 10 and 11, the heating module 14 is positionable adjacent the housing 20, and configured to heat at least a portion of the space 30 to a predetermined minimum temperature. The module 14, as is typical in the art, may therefore include a sufficiently sized blower 40, a resistance heating unit 42, and a controller 44 communicatively coupled to and configured to selectively actuate the blower 40 and unit 42. An adequate circuit (not shown) and a readily accessible and sufficient power source are provided to effect the intended function of the apparatus 10. For example, 120-volt standard utility power, 600 to 1250 watt, and 10.5 amp circuit characteristics may be utilized to produce a temperature range of 60 to 82 degrees Celsius (or 140 to 180 degrees Fahrenheit) within the space 30.

More preferably, the module 14 further includes a sensor 46 (e.g., a snap disc thermostat, electrical thermistor, etc.) that measures the temperature of the return air from the space 30 and is configured to actuate the heating unit 42 and blower 40 based on data transmitted to the controller 44. As shown in FIG. 8, so as to maintain modularity, the sensor 46 is preferably retained within the module 14 at or near the point of air re-entry. Alternatively, the sensor 46 may be attached to the exterior side of the module 14 adjacent the space 30 as shown in FIG. 10. Where temperature sampling is desired at a location spaced from the module, the controller 44 is preferably wirelessly coupled to the sensor 46 through conventional methodology (FIG. 11).

Finally, the module 14 includes an exterior frame 48 (FIG. 3) for providing rigid interconnection with the housing 20, and for solely securing and protecting the components and constituent circuits necessary to heat the space 30, including the heating unit 42, blower 40, controller 44 and sensor 46. As a result, the preferred housing 20 is devoid of electromechanical components and controls, so that no wire conductors intermediately couple the module 14 and housing 20. Thus, a fully modular apparatus 10 that facilitates dismantling is presented.

Another aspect of the present invention is the relative configuration of the housing 20 and module 14, and more particularly, the ability of the module 14 to expose a substantial portion of the interior space 30 when disconnected from the housing 20. For example, as shown in the illustrated embodiment, the housing 20 and module 14 cooperatively present a polygonal cabinet having a plurality of integrated sides when interconnected (FIGS. 2 and 3). The module 14 substantially constitutes the rear planar member or side, so as to substantially expose the interior space 30 when disconnected from the housing 20 (FIG. 9). It is further desirous for at least one other side defined by the housing 20 to be securely interfitted but detached from the remaining sides, so as to be manually removable and further expose the interior space 30 when removed. To that end, the top planar member or side 20t may be slidably interfitted within a plurality of tracks 50 defined by and at the upper edge of the front and lateral sides (FIG. 3). In this configuration, the top member 20t is preferably removable only from the rear and when the module 14 has initially been removed; alternatively, the top member 20t may be removable from the front irrespective of the removal of the module 14.

Next, as shown in FIGS. 2, 3 and 6, a compressible lining 52 intermediate the module 14 and housing 20 is preferably provided to form a seal therebetween when the module 14 and housing 20 are interconnected by the holding element 18. The lining 52 may be a soft compressible material, an accordion strip, or an equivalent that is adhered to the housing 20 or module 14 along the interface.

Finally, as shown in FIGS. 8 through 11, the preferred housing 20 and false bottom 32 are cooperatively configured with the module 14 to form a closed plenum 54 adjacent the space 30 when interconnected. The plenum 54 is configured to carry heated air from the module 14 to the space 30 and defines a first set of louvers 56, whose centroid is within a minimum distance from the outlet 24. As such, the preferred plenum 54 horizontally extends along the false bottom 32 and the louvers 56 are configured to convey the heated air from the plenum 54 to the space 30 (FIG. 8). So as to further facilitate dismantling and post-treatment repair or maintenance, the preferred false bottom 32 is also detachable.

More preferably, the plenum 54 further defines a second set of louvers 58 spaced from the first set 56 to increase uniformity of heating. It is appreciated that the louvers 56,58 must be cooperatively sized to result in the desired (e.g., equal) discharge or pattern of heated air. In this configuration, the module 14 and housing 20 may cooperatively present a longitudinally “L”-shaped plenum 60 (FIGS. 8, 10 and 11) having the previously described horizontally extending bottom section 54, a bend 60a, and a vertical rear extending section 60b. More preferably, the plenum 60 presents a chamfered slope at the bend 60a, so as to reduce energy loss in airflow, and to direct the products 12 towards the outlet 24. The vertical plenum section 60b is preferably formed within the module 14 itself (FIGS. 8 and 10) so that upon removal of the module 14 from the housing 20 the interior space 30 is exposed. However, as shown in FIG. 11, the vertical leg of the plenum 60 may be further formed by a detachable false back 62 held in place by supports (not shown). In this configuration, it is appreciated that the capacity of the interior space 30 is further truncated; however, it is also appreciated that the resulting vertical space defined by the false back 32 and module 14 forms a trap for catching food particles that would otherwise enter the module 14.

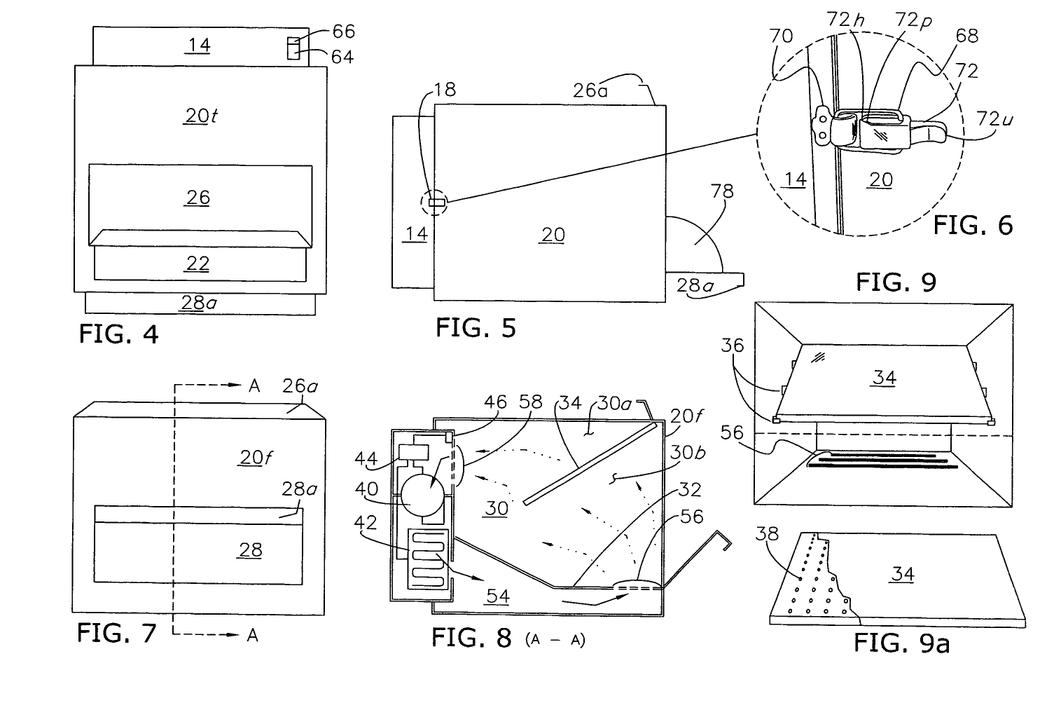

As previously mentioned, the second set of louvers 58 preferably present a second register for delivering heated air into the space (FIG. 10). Alternatively, however, the second set of louvers 58 may present a return through which previously heated air is returned to the module 14, so as to form a closed loop heating cycle (FIGS. 8 and 11). In this configuration, the second set of louvers 58 are preferably positioned as high as the module 14 or false back 62 will allow, and the plenum 60 is bifurcated so as to separate returned and heated air. More particularly, the plenum presents bifurcated input and output sections 60i,o, as best shown in FIG. 11. The second set of louvers 58 are fluidly coupled to the input section 60i, the first set of louvers 56 are fluidly coupled to the output section 60o, and the blower 40 is further configured to cause air to flow from the input section 60i and towards the heating unit 42 and output section 60o. By recycling previously heated air, it is appreciated that this configuration presents a more thermally efficient heating apparatus.

Where closed loop heating is provided, the preferred module 14 further includes a fresh air intake 64 exposed to ambient air (FIGS. 3 and 4), so as to maintain the proper humidity and “freshness” of the treating air. In this configuration, the module 14 receives and combines air from the intake 64 and input section 60i, heats the combined air, and conveys the heated mixture to the output section 60o. The preferred module 14 is further configured to modify the intake 64, so as to vary the rate of ambient air introduction. For example, the module 14 may include a manually or automatically actuated door 66 for incrementally closing an orifice defined by the intake (FIGS. 3 and 4).

As shown in FIG. 6, the holding element 18 is configured to generate a holding force between the module 14 and housing 20 when in the fastened or coupled condition, and be manually operable by a human user. As such, the element 18 presents an ergonomic configuration that allows a human hand to manipulate its components so as to easily connect and disconnect the module 14 and housing 20. A preferred embodiment of the element 18 includes a plurality of snap-action composite clips, each having mated male and female parts 68,70. As shown in FIG. 6, the male part 68 is fixedly attached to the vertical side of the housing 20, while the female part 70 is fixedly attached to the corresponding side of the module frame 48.

More preferably, the element 18 provides mechanical advantage to the user. As shown in FIG. 6, one such embodiment in this regard may include a lever arm 72 presenting a user engaging end 72u, a housing engaging end 72h, and a pivot axis 72p intermediate the ends and substantially closer to the housing engaging end 72h. In this configuration, once the male loop part 68 has been received by the female part 70, the lever arm 72 is seated within the clip and rotated towards the housing 20 until it snaps into a secure position. The rotational displacement causes the loop part to linearly translate and pull the female part 68 towards the housing 20 with a greater force than that which is imparted on the arm 72. It is appreciated that other fasteners provide likewise mechanical advantage, such as the rotational/linear advantage offered by threaded bolts and screws, however, again the present invention offers a manually operable mechanism.

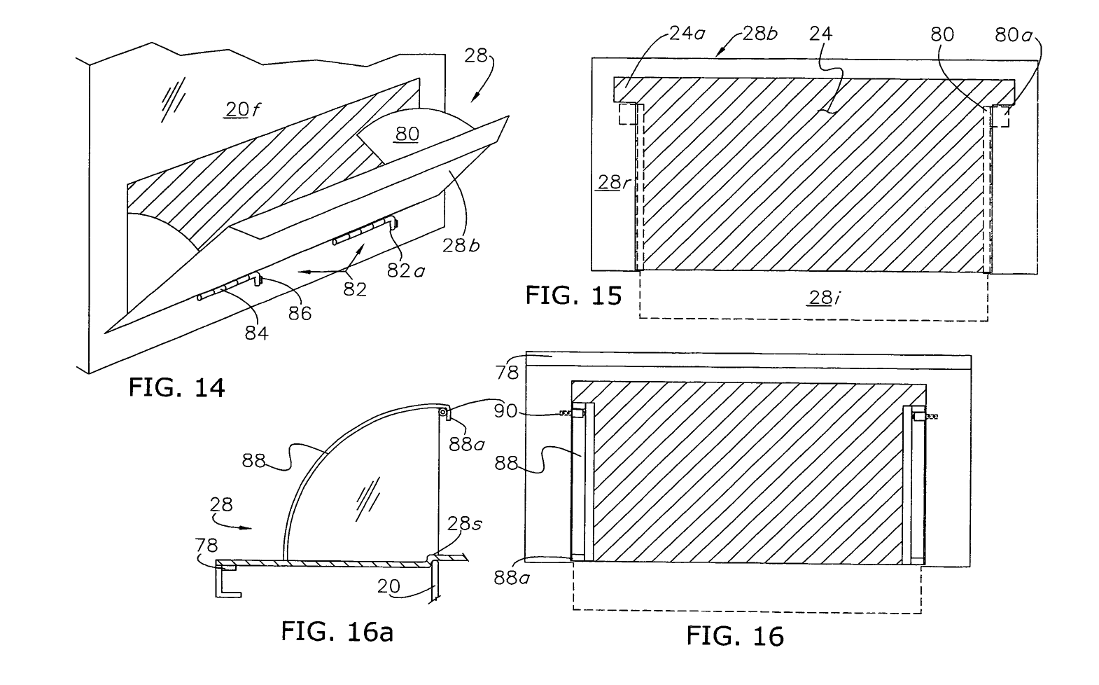

Yet another aspect of the present invention is that the doors 26,28 are securely intermitted but detached from the housing 20, so as to also be manually removable by the user. FIGS. 12 through 16 illustrate exemplary configurations to be used in conjunction with either the inlet or outlet doors 26,28 interchangeably. FIG. 12 shows a sliding inlet door 26 preferably for acting upon a horizontal surface as presented by the inlet 22 in the illustrated embodiment. In this configuration, the housing 20 preferably defines opposite parallel tracks 74 adjacent the inlet 22, and the door 26 translates within the tracks 74. The receptacle 16 further includes bent tabs 76 attached to the housing 20 at or near an end of the tracks 74 for securing the door 26 in the closed condition. As best shown in FIG. 13, the tabs are configured and located to abut the door 26 in the closed condition, so as to prevent further lateral translation. More preferably, each tab 76 further includes a bent projection 76a that biasingly engages the front lip of the door 26, so as to prevent upward movement. As shown in FIG. 12, the preferred tracks 74 are exposed for a minimum (e.g., a third of the length of the door) distance adjacent the tab end, so as to enable the door 26 to be removed by lifting the door 26 off the track 74 as it translates to the closed condition. The track 74 is preferably configured so as not to scar the door 26 as it slidably engages the beginning of the exposure.

Where the doors 26,28 and housing 14 are metallically composed, the doors 26,28 may be further secured in the closed condition by magnetic force. To that end, a magnet 78 is preferably provided adjacent the door handle 26a,28a. More particularly, the magnet 78 is positioned so as to engage the exterior surface of the main panel 28b adjacent the door handle 28a. More preferably, a magnetic strip 78 is provided along the entire width of the handle 28a as shown in FIGS. 16 and 16a.

The outlet door 28, shown in the illustrated embodiments, presents a vertical orientation. In this configuration, the door 28 pivots outward from an upright closed condition to a preferred maximum open angle of at least ninety-degrees (FIGS. 5, 10 and 11). The door 28 preferably includes side planar members or flanges 80 orthogonally projecting from the interior surface of the main planar member 28b (FIGS. 14 and 16a). The flanges 80 are spaced a distance slightly less than the outlet width, so as to be generally adjacent the sides of the outlet 24 and present a standard bin (FIG. 14). The flanges 80, as is customary in the art, each present arcuate upper edges and straight rear radial edge, so as to maintain constant bin height as the door 28 pivots towards the maximum open condition.

In a first preferred embodiment of the invention, the door 28 is pivotally coupled to the housing 20 along its lower edge by at least one manually removable shoulder bolt 82 (FIG. 14). More preferably, the shoulder bolt 82 is configured to be superjacently received by a plurality of aligned sleeves 84 alternatingly attached to the housing 20 adjacent the bottom of the outlet 24 and to the door 28 adjacent the bottom of the main member 28b. A non-inserted portion 82a of the preferred bolt is bent ninety-degrees from the inserted axis, and is able to be swung downwards to a secure position. In this position, the lateral translation of the bolt 82 is cooperatively prevented by a stop 86 defined by or attached to the housing 20 and the sleeves 84. To remove the bolt 82 from the sleeves 84, the user must first swing the non-inserted portion 82a upwards until it clears the stop 86.

In a second preferred embodiment of the invention, the outlet 24 (or an upright inlet 22) presents lowermost and maximum widths, which may be congruent, as shown in the single rectangular section in FIGS. 15 and 16. In this embodiment, the manually removable vertical door 28 includes an outlet insertable planar bottom portion 28i defining a constant width slightly less than the lowermost width and a remaining portion 28r having a constant width greater than the maximum width, such that the outlet door 28 is only partially insertable within the outlet 24 and generally not laterally translatable. As shown in FIGS. 15 and 16, the door 28 may present adjacent rectangular sections of differing widths. Finally, the door 28 preferably presents an “S”-shaped bend 28s intermediate the insertable and remaining portions 28i,r (FIG. 16a), which enables the door to achieve a flush co-planar front surface with the housing 20, and more securely rest upon the outlet 24 in the closed condition.

Though removably detached from the housing 20, the door 28 in the second embodiment is configured in accordance therewith to prevent inadvertent removal from the outlet 24. For example, and as shown in FIG. 15, each flange 80 may include an outwardly projecting holding flap 80a adjacent its rear and upper edges. The flap 80a, flange height, and outlet 24 are cooperatively configured such that the flap 80a catches the housing 20 in the ninety-degree open condition, so as to form a stop. The housing 20 in turn defines opposite upper outlet notches 24a that are configured to receive the flaps 80a. The outlet notches 24a and flange height are cooperatively configured such that the door 28 is removable only by lifting the door 28 in the ninety-degree open condition until the flaps 80a align with the notches 24a.

In the alternative door stop configuration, also shown in FIGS. 16 and 16a, the vertical door 28 includes an outwardly projecting arcuate race 88 attached to each flange 80, and the receptacle 16 further includes two opposite pin and wheel assemblies 90 inwardly projecting within the outlet 24, and affixed to the housing 20 adjacent the outlet 24 and within the interior space 30. The assemblies 90, outlet 24, and flange spacing are cooperatively configured such that the races 88 rest upon and rollingly engage the assemblies 90 as the door 28 is pivoted between open and closed conditions. Each of the races 88 includes a generally perpendicular end section 88a configured to catch the assemblies 90 when the door 28 is pivoted to the ninety-degree open condition (FIG. 16a). The races 88 do not include a lower longitudinal member that extends below the assemblies 90 so that the door 28 can be manually lifted from the outlet 24. It is appreciated that in this configuration the false bottom must be configured to accommodate the swing action of the outlet insertable section 28i.

Finally, as shown through out the illustrated embodiments, both door handles 26a,28a, whether slidably or pivotally operational, preferably consists of a bent portion at the foremost or upper end of the respective door. The bent portion preferably presents an outwardly projecting upper portion and more preferably a distal end section distending from the upper portion. The preferred bent portion extends the entire width of the door, and is lined with a relatively soft grip promoting material (not shown), such as a thermoplastic elastomer, rubber, or foam. It is appreciated that the integral door/handle configuration results in reduced manufacturing and assembly costs, as well as a larger full width handle for convenience.

In operation, the products 12 are introduced through the inlet 22 when the inlet door 26 is in an open condition, and retained and heated in the interior space 30 after the inlet door 26 is returned to the closed condition. It is desirous to implement a product tracking system, which includes measuring an average product discharge rate with respect to capacity, in order to assure that the products 12 are heated and otherwise treated for a sufficient period (e.g., 15 minutes for tortilla chips). After the module 14 is activated (preferably by a lighted on/off switch), the sensor 46 reads the temperature within the space 30. If the temperature is below a minimum threshold (e.g., 49 degrees (C.) or 120 degrees (F.)), the controller 44 initially causes the heating unit 42 to activate and then the blower 40 after a predetermined delay (e.g., 10 seconds). Likewise, the sensor 46 and controller 44 continually monitor the temperature within the space 30, and cooperatively cause the blower 40 and heating unit 42 to deactivate if the temperature surpasses a maximum threshold (e.g., 93 degrees (C.) or 200 degrees (F.)). Once treated, the products 12 are removed from the receptacle 16 by opening the outlet door 28 preferably to the ninety-degree open condition (FIG. 5). If greater than ninety-degree access is desired, it is appreciated that flange dimensions may be modified and adjustable legs (not shown) may be added to the apparatus 10.

After all products 12 have been removed, the apparatus 10 may be broken-down to facilitate cleaning, maintenance, and/or repair by first manually uncoupling each clip of the holding element 18, so as to disconnect the heating module 14. Next, the doors 26,28, false bottom 32, and baffle 34 are manually removed by lifting them from the housing 20, so as to further expose the interior space 30. The detached components can then be sanitized or cleaned. The user can further access the interior space 30 as well as the area beneath the false bottom 32 without obstruction, in order to clean, maintain and/or repair the apparatus 10.

Although the present invention has been described with reference to the preferred embodiments described herein and illustrated in the drawings, it is noted that equivalents may be employed and substitutions made herein without departing from the scope of the invention as recited in the claims. Having thus described the preferred embodiments of the invention, what is claimed as new and desired to be protected by Letters Patent includes the following:

What is claimed is:

1. A food receptacle and modular heating apparatus adapted to retain, heat, and dispense a quantity of food products on a first-in-first-out basis, and be facilely dismantled by a human user, said apparatus comprising:
a main housing defining an interior space wherein the products are retained and heated, an inlet communicatively coupled to the space and configured to receive the food products, and an outlet spaced from the inlet, communicatively coupled to the space and configured to dispense the products;
a heating module positionable adjacent the housing, and configured to heat at least a portion of the space to a predetermined minimum temperature; and
a holding element configured to interconnect, generate a holding force between, and disconnect the module and housing,
said element being manually operable by the user, such that the module is connectable to and disconnectable from the housing without the use of a tool.

2. The apparatus as claimed in claim 1, wherein the element includes a plurality of composite clips each having mated female and male parts separately attached to the module and housing respectively.

3. The apparatus as claimed in claim 1, wherein the element provides mechanical advantage to the user.

4. The apparatus as claimed in claim 3, wherein the element includes a lever arm presenting a user engaging end, a housing engaging end, and a pivot axis intermediate the ends and substantially closer to the housing engaging end.

5. The apparatus as claimed in claim 1, wherein the module includes a blower, a heating unit, and a controller communicatively coupled to and configured to selectively actuate the blower and unit.

6. The apparatus as claimed in claim 1, wherein the housing and module cooperatively present a polygonal cabinet having a plurality of integrated sides when interconnected, and the module substantially constitutes a side, so as to substantially expose the interior space when disconnected from the housing.

7. The apparatus as claimed in claim 6, wherein at least one side defined by the housing is securely interfitted and detached from the remaining sides, so as to be manually removable and further expose the interior space when removed.

8. The apparatus as claimed in claim 1, further comprising:
a compressible lining intermediate the module and housing and configured to form a seal therebetween when the module and housing are interconnected.

9. The apparatus as claimed in claim 1, wherein at least a portion of the housing is formed of a multi-layered wall, including a protective exterior layer, an insulation layer, and an interior layer that is heat resistant, non-corrosive, and non-reactive to the food products.

10. The apparatus as claimed in claim 1, wherein the housing presents an uppermost surface, the uppermost surface defines the inlet, the apparatus further comprises a door positioned relative to and configured to cover the inlet, the door is detachably interfitted with the housing, and the door and housing are cooperatively configured such that the door is slidably translatable between open and closed conditions.

11. The apparatus as claimed in claim 10, wherein the housing defines opposite parallel tracks adjacent the inlet, the door is slidably translatable within the tracks, the housing further includes bent tabs at or near an end of the tracks and configured to cooperatively secure the door in the closed condition, and the tracks are exposed for a minimum distance adjacent the tab end, so as to enable the door to be removed by lifting the door as it translates to the closed condition.

12. The apparatus as claimed in claim 1, wherein the housing and module are cooperatively configured to form a closed plenum adjacent the space when interconnected, the plenum is configured to carry heated air from the module to the space and defines a first set of louvers within a minimum distance from the outlet, and the louvers are configured to convey the heated air from the plenum to the space.

13. The apparatus as claimed in claim 12, wherein the plenum further defines a second set of louvers spaced from the first set, and the first and second sets are cooperatively configured to heat the products.

14. The apparatus as claimed in claim 13, wherein the housing presents a cubical cabinet, the plenum presents a longitudinal “L” shape having a horizontal bottom extending section, a bend, and a vertical rear extending section, the first set of louvers are defined by the bottom section, and the second set of louvers are defined by the rear section.

15. The apparatus as claimed in claim 14, wherein the housing and module further define a plenum having a chamfered slope at the bend, so as to reduce energy loss caused by the bend and direct the products towards the outlet.

16. The apparatus as claimed in claim 13, wherein the plenum presents bifurcated input and output sections, the second set of louvers present a return communicatively coupled to the input section, the first set of louvers are communicatively coupled to the output section, and the module is further configured to receive air from the input section, heat the received air, and convey the heated air to the output section, so as to form a closed loop heating cycle.

17. The apparatus as claimed in claim 16, wherein the module further includes a fresh air intake communicatively coupled to ambient air, and is configured to receive air from the intake and input section, heat the received air, and convey the heated air to the output section.

18. The apparatus as claimed in claim 17, wherein the intake is configured to receive ambient air at a first rate, and the module is further configured to modify the intake, so as to vary the rate.

19. A food receptacle and modular heating apparatus adapted to retain, heat, and dispense a quantity of food products and be facilely dismantled by a human user, said apparatus comprising:
a main housing defining an interior space wherein the products are retained, and heated, an inlet communicatively coupled to the space and configured to receive the products, and an outlet communicatively coupled to and configured to dispense the products from the space;
a first door positioned relative to the inlet, detachably interfitted with the housing, and translatable between an open condition and a closed condition wherein the inlet is covered so as to further enclose the space;
a second door positioned relative to the outlet, detachably interfitted with the housing, and translatable between an open condition and a closed condition wherein the outlet is covered so as to further enclose the space;
a heating module positionable adjacent the housing, and configured to heat at least a portion of the space to a predetermined minimum temperature; and
a holding element configured to interconnect the module and housing, and generate a holding force therebetween,
said element being manually operable by the user, such that the module is connectable to and disconnectable from the housing without the use of a tool.

20. The apparatus as claimed in claim 19, wherein the inlet presents lowermost and maximum widths, and the first door includes an inlet insertable planar bottom portion defining a constant width less than the lowermost width and further including a remaining portion having a constant width greater than the maximum width, such that the first door can only be partially inserted within the inlet.

21. The apparatus as claimed in claim 19, wherein the inlet presents a constant lateral inlet width, the first door includes a planar member having a minimum width greater than the inlet width and two flanges orthogonally projecting from the planar member and into the space, the flanges are spaced a distance slightly less than the inlet width, such that the flanges are generally adjacent the housing and the planar member and flanges cooperatively present a bin in the open condition.

22. The apparatus as claimed in claim 21, wherein each flange presents a straight rear edge, a height as measured along the straight rear edge, and an upper arcuate edge, and includes an outwardly projecting holding flap adjacent the rear and upper edges, the flap, flange height, and inlet are cooperatively configured such that the flap catches the housing in the open condition and forms a stop, the inlet includes opposite upper notches configured to receive the flaps, and the inlet and flange height are cooperatively configured such that the door is removable only by lifting the door in the open condition until the flaps reach the notches.

23. The apparatus as claimed in claim 21, wherein each flange includes an outwardly projecting arcuate race, and the housing includes two opposite pin and wheel assemblies inwardly projecting within the inlet, the inlet and first door being cooperatively configured such that the races rest upon and rollingly engage the assemblies as the door is pivoted between the open and closed conditions.

24. The apparatus as claimed in claim 23, wherein the races each include a generally perpendicular end section configured to catch the assemblies when the door is pivoted to the open condition and not a lower longitudinal section extending below the assembly, so that the door can be manually lifted from the inlet in the open condition.

25. The apparatus as claimed in claim 19, wherein each door presents a bent planar member having an outwardly projecting upper portion and a distal end section distending from the upper portion, so as to form a handle.

26. The apparatus as claimed in claim 19, wherein the housing includes at least one inclined baffle configured to direct the products away from the inlet and toward the outlet.

27. The apparatus as claimed in claim 26, wherein said inlet, outlet, and said at least one baffle are cooperatively configured to cause the products to be dispensed on a first-in-first-out basis.

28. The apparatus as claimed in claim 26, wherein the housing includes an exterior cabinet having internal supports, and the baffle presents a planar screen, rests upon the supports, and is detachably intermitted with the cabinet, so as to be manually removable by the user without the use of a tool.

29. The apparatus as claimed in claim 26, wherein the food products present a minimum diameter, said at least one baffle defines a plurality of through holes, and each hole presents a maximum diameter less than the minimum product diameter, so as to allow the passage of air and not food products.

30. A heating module adapted for use and facile interconnection with a food receptacle housing configured to receive, retain, heat and dispense a quantity of food products, said module comprising:
a heating unit configured to increase the temperature of ambient adjacent air;
a blower configured to direct air adjacent the heating unit and towards the space;
a sensor configured and located so as to measure the temperature of the air inside the space;
a controller communicatively coupled to the sensor, heating unit and blower, and configured to selectively actuate the heating unit and blower;
an exterior frame configured to secure the heating unit, blower, sensor and controller, and be manually and removably interconnected with the housing so as to cooperatively define a substantially enclosed space wherein the products are retained and heated; and
a holding element fixedly attached to the frame, and configured to engage the housing so as to hold the frame and housing in a fixed relative condition,
said element being manually operable by the user, such that the module is connectable to and disconnectable from the housing without the use of a tool.
